(19) United States
(12) Patent Application Publication
(10) Pub. No.: US 2018/0324618 A1
(43) Pub. Date: Nov. 8, 2018

(54) UNSOLICITED COLLOCATED INTERFERENCE REPORTING AND PHYSICAL LAYER PARAMETER CONTROL FOR IN-DEVICE COEXISTENCE

(71) Applicant: Intel IP Corporation, Santa Clara, CA (US)

(72) Inventors: Dor CHAY, Tel Aviv (IL); Ido OUZIELI, Tel Aviv (IL); Ofer HAREUVENI, Haifa (IL); Ilan SUTSKOVER, Hadera (IL)

(21) Appl. No.: 15/772,482

(22) PCT Filed: Jun. 30, 2016
(86) PCT No.: PCT/US2016/040345

§ 371 Date: Apr. 30, 2018

Related U.S. Application Data
(60) Provisional application No. 62/387,254, filed on Dec. 23, 2015.
(60) Provisional application No. 62/387,128, filed on Dec. 23, 2015.

(51) Int. Cl. H04W 24/10; H04W 72/12

(52) U.S. Cl. CPC H04W 24/10; H04W 88/06; H04W 72/1215

(57) ABSTRACT

This disclosure describes methods, apparatus, and systems related to unsolicited collocated interference reporting and physical layer parameter control for in-device coexistence. A device may determine one or more interference characteristics from one or more collocated in-device components associated with one or more collocated communications standards. The device may encode an information element with information associated with the one or more interference characteristics. The device may cause to send a frame comprising the information element to an access point.

### CROSS-REFERENCE TO RELATED APPLICATIONS

This application claims the benefit of U.S. Provisional Application No. 62/387,128 filed Dec. 23, 2015, and U.S. Provisional Application No. 62/387,254 filed Dec. 23, 2015, the disclosure of which are incorporated herein by reference as if set forth in full.

### TECHNICAL FIELD

This disclosure generally relates to systems and methods for wireless communications and, more particularly, to unsolicited interference reporting and parameter control in wireless communications.

### BACKGROUND

Efficient use of the resources of a wireless local-area network (WLAN) by wireless devices is important to provide bandwidth and acceptable response times to the users of the WLAN. However, often there are many wireless devices trying to share the same resources. Moreover, wireless devices may need to operate with both newer protocols and with legacy device protocols.

### BRIEF DESCRIPTION OF THE DRAWINGS

FIG. 1 depicts a network diagram illustrating an example network environment of an illustrative unsolicited collocated interference reporting and physical layer parameter control system, according to one or more example embodiments of the disclosure.

FIG. 2 depicts a diagram illustrating an information element format for unsolicited collocated interference reporting, according to one or more example embodiments of the disclosure.

FIG. 3 depicts a diagram illustrating an information element format for physical layer parameter control, according to one or more example embodiments of the disclosure.

FIG. 4 depicts an illustrative schematic diagram of an information element based communication for unsolicited collocated interference reporting, in accordance with one or more example embodiments of the present disclosure.

FIG. 5 depicts an illustrative schematic diagram of an information element based communication for physical layer parameter control, in accordance with one or more example embodiments of the present disclosure.

FIG. 6 depicts a flow diagram of an illustrative process for an illustrative unsolicited collocated interference reporting and physical layer parameter control system, in accordance with one or more example embodiments of the present disclosure.

FIG. 7 depicts a flow diagram of an illustrative process for an illustrative unsolicited collocated interference reporting and physical layer parameter control system, in accordance with one or more example embodiments of the present disclosure.

FIG. 8 illustrates a functional diagram of an example communication station that may be suitable for use as a user device, in accordance with one or more example embodiments of the present disclosure.

FIG. 9 is a block diagram of an example machine upon which any of one or more techniques (e.g., methods) may be performed, in accordance with one or more example embodiments of the present disclosure.

### DETAILED DESCRIPTION

Example embodiments described herein provide certain systems, methods, and devices, for providing signaling to Wi-Fi devices in various Wi-Fi networks, including, but not limited to, IEEE 802.11ax (referred to as HE or HEW).

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

Example embodiments of the present disclosure relate to systems, methods, and devices for unsolicited collocated interference reporting and physical layer parameter control for in-device coexistence. In one embodiment, unsolicited collocated interference reporting may include reporting that is initiated by a user device without being instructed by an access point to report interference. A device may be instructed to determine one or more interference characteristics from one or more collocated in-device components associated with one or more collocated communications standards. For example, the collocated communications standards may include a Wi-Fi standard, a Long Term Evolution (LTE) standard, a Bluetooth standard, or other communication standards (e.g., CDMA, NFC, etc.). The device may be instructed to encode an information element with information associated with the one or more interference characteristics. The device may be instructed to send a frame comprising the information element to an access point.

In one embodiment, the information associated with the one or more interference characteristics may include a collocated interference report indicating interference the device is subject to. For example, the interference characteristics may include an interference level, an interference center frequency, an interference bandwidth, an interference level accuracy, an interference index, an interference interval, an interference burst length, an interference start time, or an interference duty cycle.

In one embodiment, the information associated with the one or more interference characteristics may include one or more physical layer parameters to operate with the one or more collocated communications standards. For example, the physical layer parameters may include a maximum transmit power, a recommended maximum transmit power, a maximum modulation and coding scheme, or a maximum number of spatial streams. The device may be instructed to utilize the maximum number of spatial streams for transmitting an acknowledgement, a block acknowledgement, and a clear-to-send frame.

In one embodiment, an access point may be instructed to receive a frame including an information element from a user device. The information element may include information associated with one or more interference characteristics associated with one or more collocated communications standards. The one or more collocated communications standards may include an LTE standard or a Bluetooth standard. The access point may further be instructed to decode the information element, adjust scheduling data or modulation and coding scheme data for the user device, encode a frame with the adjusted scheduling data or modulation and coding scheme data, and send the encoded frame to the user device.

In one embodiment, the one or more interference characteristics may include an interference level, an interference center frequency, an interference bandwidth, an interference level accuracy, an interference index, an interference interval, an interference burst length, an interference start time, or an interference duty cycle.

In one embodiment, the one or more interference characteristics may include one or more physical layer parameters to operate with the one or more collocated communications standards. The one or more physical layer parameters may include a maximum transmit power, a recommended maximum transmit power, a maximum modulation and coding scheme, and a maximum number of spatial streams.

The above descriptions are for purposes of illustration and are not meant to be limiting. Numerous other examples, configurations, processes, etc., may exist, some of which are described in detail below. Example embodiments will now be described with reference to the accompanying figures.

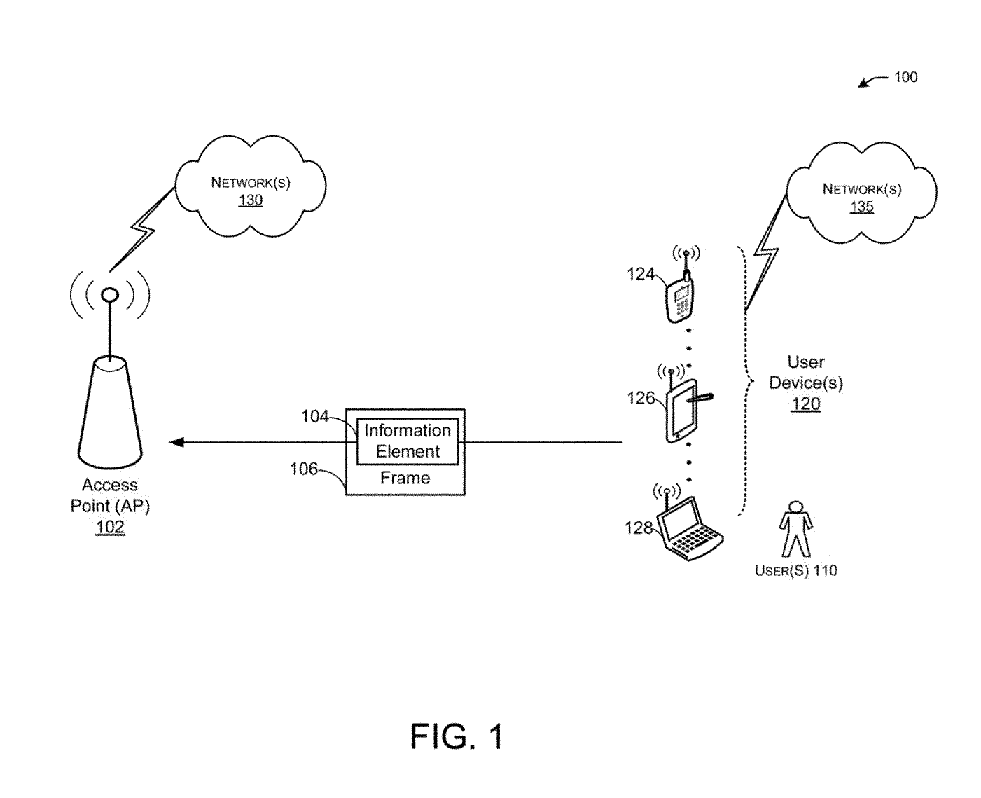

FIG. 1 is a network diagram illustrating an example network environment, according to some example embodiments of the present disclosure. Wireless network 100 may include one or more devices 120 and one or more access point(s) (AP) 102, which may communicate in accordance with IEEE 802.11 communication standards, including IEEE 802.11ax. The device(s) 120 may be mobile devices that are non-stationary and do not have fixed locations.

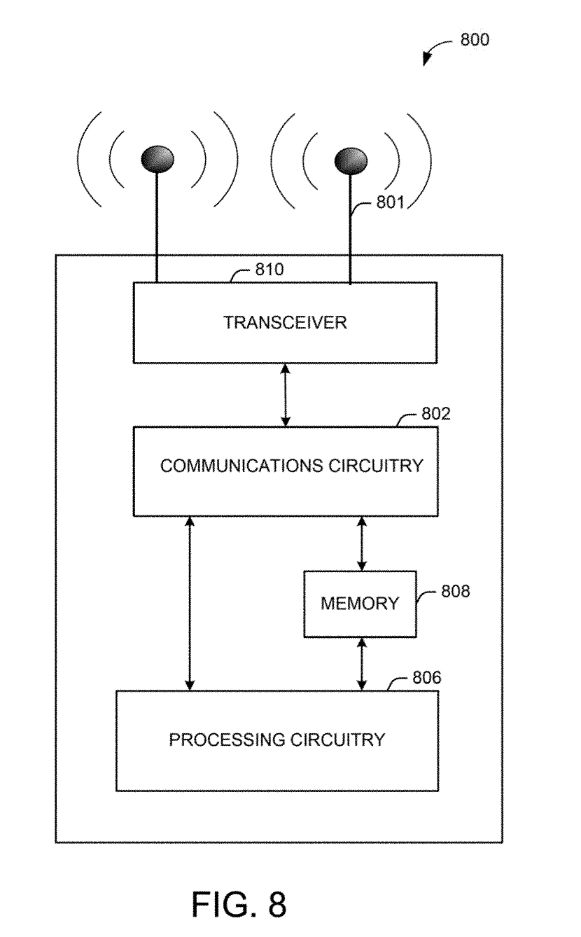

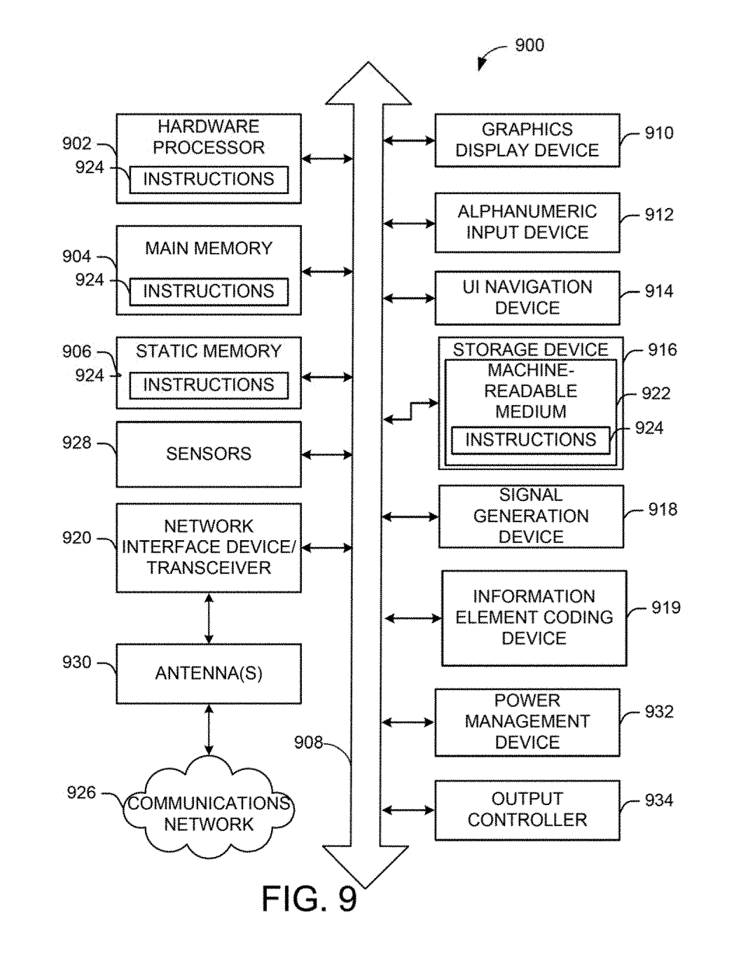

In some embodiments, the user devices 120 and AP 102 may include one or more computer systems similar to that of the functional diagram of FIG. 8 and/or the example machine/system of FIG. 9.

One or more illustrative user device(s) 120 and/or AP 102 may be operable by one or more user(s) 110. The user device(s) 120 (e.g., 124, 126, or 128) and/or AP 102 may include any suitable processor-driven device including, but not limited to, a mobile device or a non-mobile, e.g., a static, device. For example, user device(s) 120 and/or AP 102 may include, a user equipment (UE), a station (STA), an access point (AP), a personal computer (PC), a wearable wireless device (e.g., bracelet, watch, glasses, ring, etc.), a desktop computer, a mobile computer, a laptop computer, an Ultrabook™ computer, a notebook computer, a tablet computer, a server computer, a handheld computer, a handheld device, an internet of things (IoT) device, a sensor device, a PDA device, a handheld PDA device, an on-board device, an off-board device, a hybrid device (e.g., combining cellular phone functionalities with PDA device functionalities), a consumer device, a vehicular device, a non-vehicular device, a mobile or portable device, a non-mobile or non-portable device, a mobile phone, a cellular telephone, a PCS device, a PDA device which incorporates a wireless communication device, a mobile or portable GPS device, a DVB device, a relatively small computing device, a non-desktop computer, a “carry small live large” (CSLL) device, an ultra mobile device (UMD), an ultra mobile PC (UMPC), a mobile internet device (MID), an “origami” device or computing device, a device that supports dynamically composable computing (DCC), a context-aware device, a video device, an audio device, an A/V device, a set-top-box (STB), a blu-ray disc (BD) player, a BD recorder, a digital video disc (DVD) player, a high definition (HD) DVD player, a DVD recorder, a HD DVD recorder, a personal video recorder (PVR), a broadcast HD receiver, a video source, an audio source, a video sink, an audio sink, a stereo tuner, a broadcast radio receiver, a flat panel display, a personal media player (PMP), a digital video camera (DVC), a digital audio player, a speaker, an audio receiver, an audio amplifier, a gaming device, a data source, a data sink, a digital still camera (DSC), a media player, a smartphone, a television, a music player, or the like. It is understood that the above is a list of devices. However, other devices, including smart devices such as lamps, climate control, car components, household components, appliances, etc. may also be included in this list.

Any of the user device(s) 120 (e.g., user devices 124, 126, 128), and AP 102 may be configured to communicate with each other via one or more communications networks 130 and/or 135 wirelessly or wired. Any of the communications networks 130 and/or 135 may include, but not limited to, any one of a combination of different types of suitable communications networks such as, for example, broadcasting networks, cable networks, public networks (e.g., the Internet), private networks, wireless networks, cellular networks, or any other suitable private and/or public networks. Further, any of the communications networks 130 and/or 135 may have any suitable communication range associated therewith and may include, for example, global networks (e.g., the Internet), metropolitan area networks (MANs), wide area networks (WANs), local area networks (LANs), or personal area networks (PANs). In addition, any of the communications networks 130 and/or 135 may include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, white space communication mediums, ultra-high frequency communication mediums, satellite communication mediums, or any combination thereof.

Any of the user device(s) 120 (e.g., user devices 124, 126, 128), and AP 102 may include one or more communications antennas. The one or more communications antennas may be any suitable type of antennas corresponding to the communications protocols used by the user device(s) 120 (e.g., user devices 124, 126 and 128), and AP 102. Some non-limiting examples of suitable communications antennas include Wi-Fi antennas, Institute of Electrical and Electronics Engineers (IEEE) 802.11 family of standards compatible antennas, directional antennas, non-directional antennas, dipole antennas, folded dipole antennas, patch antennas, multiple-input multiple-output (MIMO) antennas, omnidirectional antennas, quasi-omnidirectional antennas, or the like. The one or more communications antennas may be communicatively coupled to a radio component to transmit and/or receive signals, such as communications signals to and/or from the user devices 120 and/or AP 102.

Any of the user device(s) 120 (e.g., user devices 124, 126, 128), and AP 102 may be configured to perform directional transmission and/or directional reception in conjunction with wirelessly communicating in a wireless network. Any of the user device(s) 120 (e.g., user devices 124, 126, 128), and AP 102 may be configured to perform such directional transmission and/or reception using a set of multiple antenna arrays (e.g., antenna arrays or the like). Each of the multiple antenna arrays may be used for transmission and/or reception in a particular respective direction or range of directions. Any of the user device(s) 120 (e.g., user devices 124, 126, 128), and AP 102 may be configured to perform any given directional transmission towards one or more defined transmit sectors. Any of the user device(s) 120 (e.g., user devices 124, 126, 128), and AP 102 may be configured to perform any given directional reception from one or more defined receive sectors.

MIMO beamforming in a wireless network may be accomplished using RF beamforming and/or digital beamforming. In some embodiments, in performing a given MIMO transmission, user devices 120 and/or AP 102 may be configured to use all or a subset of its one or more communications antennas to perform MIMO beamforming.

Any of the user devices 120 (e.g., user devices 124, 126, 128), and AP 102 may include any suitable radio and/or transceiver for transmitting and/or receiving radio frequency (RF) signals in the bandwidth and/or channels corresponding to the communications protocols utilized by any of the user device(s) 120 and AP 102 to communicate with each other. The radio components may include hardware and/or software to modulate and/or demodulate communications signals according to pre-established transmission protocols. The radio components may further have hardware and/or software instructions to communicate via one or more Wi-Fi and/or Wi-Fi direct protocols, as standardized by the Institute of Electrical and Electronics Engineers (IEEE) 802.11 standards. In certain example embodiments, the radio component, in cooperation with the communications antennas, may be configured to communicate via 2.4 GHz channels (e.g. 802.11b, 802.11g, 802.11n, 802.11ax), 5 GHz channels (e.g. 802.11n, 802.11ac, 802.11ax), or 60 GHZ channels (e.g. 802.11ad). In some embodiments, non-Wi-Fi protocols may be used for communications between devices, such as Bluetooth, global system for mobile communications (GSM), 2G, 2.5G, 3G, 3.5G, 4G, fifth generation (5G) mobile networks, 3GPP, long term evolution (LTE), LTE advanced, enhanced data rates for GSM Evolution (EDGE), dedicated short-range communication (DSRC), Ultra-High Frequency (UHF) (e.g. IEEE 802.11af, IEEE 802.22), white band frequency (e.g., white spaces), or other packetized radio communications. The radio component may include any known receiver and baseband suitable for communicating via the communications protocols. The radio component may further include a low noise amplifier (LNA), additional signal amplifiers, an analog-to-digital (A/D) converter, one or more buffers, and digital baseband.

The one or more user devices 120 (e.g., user devices 124, 126, and/or 128) may establish communication with an AP (e.g., AP 102) by communicating in the uplink direction by sending data frames. Similarly, an AP (e.g., AP 102) may establish communication with the one or more user devices 120 (e.g., user devices 124, 126, and/or 128), by communicating in the downlink direction by sending data frames. The data frames may be preceded by one or more preambles that may be part of one or more headers. These preambles may be used, for example, to allow a user device to detect a new incoming data frame from the AP. A preamble may be a signal used in network communications to synchronize transmission timing between two or more devices (e.g., between the APs and user devices). The communication may include communication between legacy devices and/or HE devices.

In one embodiment, and with reference to FIG. 1, an HE frame (e.g., frame 106) may include an information element (IE) 104. The IE 104 may be communicated between the one or more user devices 120 and the AP 102. The communication may utilize a certain frequency band (e.g., 20, 40, 80, 160 MHz, etc.) based on the device and the IEEE standard followed by the device (e.g., legacy devices or HEW device). For example, legacy devices may utilize a 20 MHz but HEW devices may support larger frequency bands. It is understood that the above acronyms may be different and not to be construed as a limitation as other acronyms maybe used for the fields included in an HEW preamble.

In one embodiment, an unsolicited collocated interference reporting and physical layer parameter control system may determine collocated interference (e.g., LTE and/or Bluetooth) at a Wi-Fi station (STA) (e.g., the one or more user devices 120) and may allow for the uplink communication of unsolicited collocated interference reports and physical layer (PHY) parameters (e.g., transmission power) even when the STA can support multiple communications standards that may cause interference (e.g., in-device coexistence). For example, the one or more user devices 120 may be configured to encode an information element (e.g., IE 104) to enable the sending of an unsolicited frame (e.g., frame 106) that includes an indication of a collocated interference report and/or preferred uplink (UL) PHY parameters over specific frames that will be triggered by an AP (e.g., AP 102). In one embodiment, the aforementioned indication may be semi-static (e.g., once every few seconds) instead of per UL frame. Once the AP receives the preferred UL parameters, it may change trigger frame requirements for a particular STA, thereby enabling the STA to obey its triggering requests and still maintain in-device coexistence.

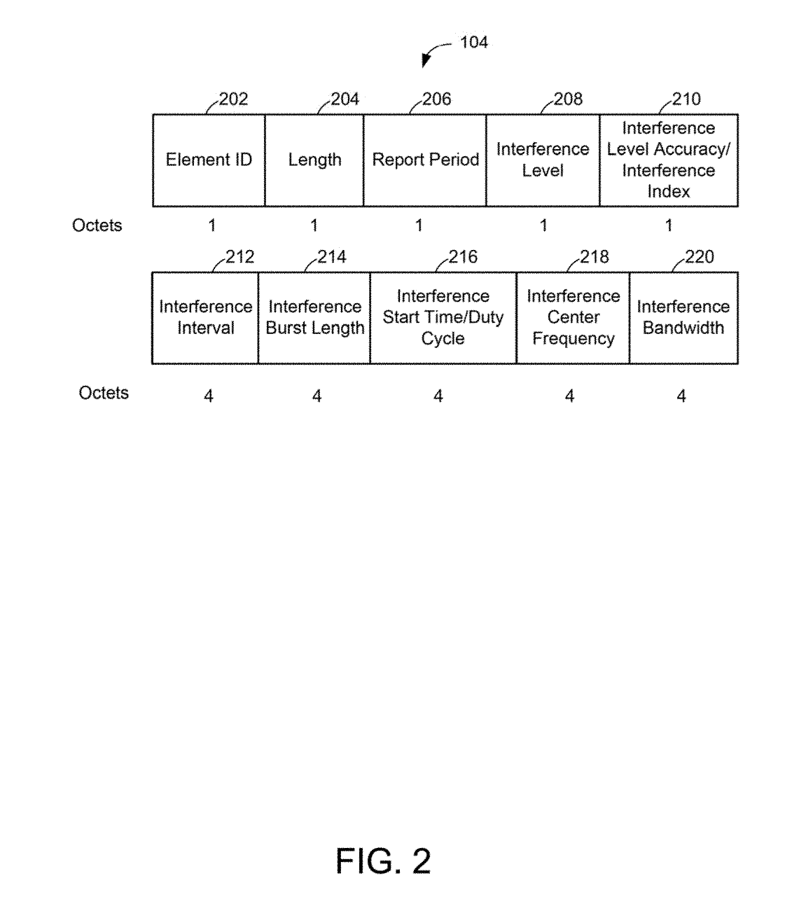

FIG. 2 depicts an illustrative information element (IE) 104 format for unsolicited collocated interference reporting (which may be based on the “collocated interference reporting” information element from the 802.11v standard), according to one or more example embodiments of the disclosure. In one embodiment, the IE 104 may be part of an unsolicited frame (e.g., the frame 106) and further may be a subsection of a frame (rather than the entire frame). The IE 104 format may include the following parameters: an Element ID 202, a Length 204, a Report Period 206, an Interference Level Accuracy/Interference Index 210, an Interference Level 212, an Interference Burst Length 214, an Interference Start Time/Duty Cycle 216, an Interference Center Frequency 218, and an Interference Bandwidth 220. In one embodiment, a STA (e.g., the one more user devices 120 of FIG. 1) may utilize the IE 104 to notify an AP (e.g., the AP 102 of FIG. 1) of several characteristics associated with collocated interference as shown below in Table 1.

TABLE 1

| Category | Field | Description | Potential Usage |
|---|---|---|---|
| RF Characteristics & | Interference Level | Maximum level of the | AP can calculate STA |
| Interference Index | | collocated interference | signal-to-noise ratio |
| | | power in units of dBm at | (SNR) |
| | | the antenna connector | |
| | Interference Center | The center frequency of | |
| | Frequency | interference in units of 5 | |
| | | kHz | |
| | Interference Bandwidth | Bandwidth in units of 5 | |
| | | kHz at the −3 dB roll-off | |
| | | point of the interference | |
| | | signal | |
| | Interference Level | Interference | Report both LTE and |
| | Accuracy/Interference | accuracy (in dB) | Bluetooth interference |
| | Index | Interference index | separately, using a |
| | | (or identifier), | different index |
| | | enables the STA to | |
| | | separately report on | |
| | | several independent | |
| | | interferences | |
| Interference Pattern | Interference Interval | Interval between two | Bluetooth: Report |
| | | successive periods of | on Synchronous |
| | | interference in | Connection- |
| | | microseconds. Enables | Oriented (SCO)/ |
| | | reporting of periodic | Enhanced SCO |
| | | interference. | (eSCO) pattern |
| | Interference Burst Length | Duration of each period | LTE: Report on |
| | | of interference in | VoLTE or any |
| | | microseconds. | periodic Time |
| | Interference Start | Least significant 4 octets | Division Duplex |
| | Time/Duty Cycle | (e.g., B0-B31) of the | (TDD) frame |
| | | Timing Synchronization | structure |
| | | Function (TSF) timer at | AP can synch to |
| | | the start of the | the reported |
| | | interference burst. This | interference pattern |
| | | in fact indicates the | |
| | | anchor point. | |

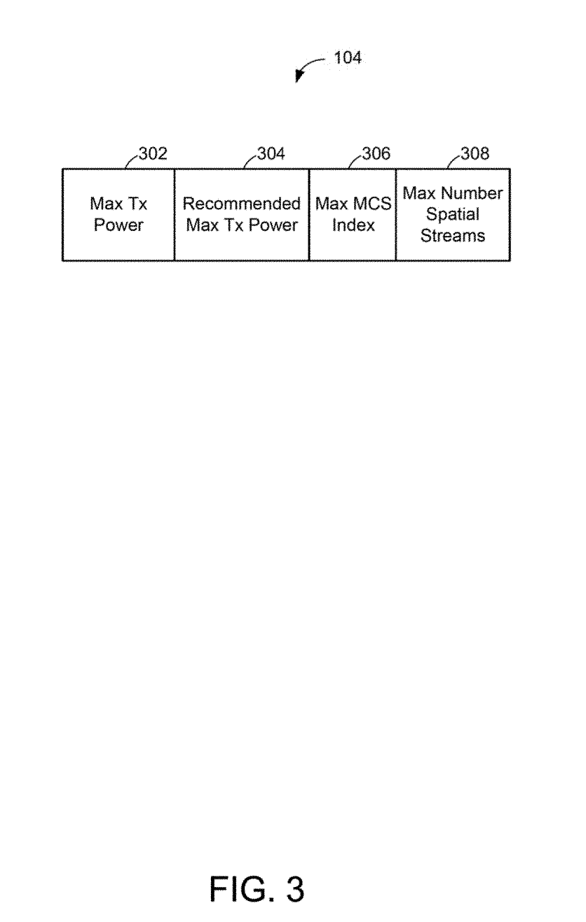

FIG. 3 depicts an illustrative information element (IE) 104 format for physical layer parameter control, according to one or more example embodiments of the disclosure. In one embodiment, the IE 104 may be part of an unsolicited frame (e.g., the frame 106 of FIG. 1) and further may be a subsection of a frame (rather than the entire frame). The IE 104 format may include the following parameters: Max Tx Power 302, Recommended Max Tx Power 304, Max MCS Index 306, and Max Number Spatial Streams 308. In one embodiment, a STA (e.g., the one more user devices 120) may utilize the IE 104 to notify an AP (e.g., the AP 102) of several PHY control parameters as shown below in Table 2.

TABLE 2

| Relevant Frames | Field | Default Value | Remarks |
|---|---|---|---|
| ACK, BA, CTS | Max Tx Power | As in association | |
| | Recommended | Max TX power | For enabling STA |
| | Max Tx Power | | multi-communication |
| | | | concurrency |
| | Max MCS index | As in association | |
| | Max number of | As in association | |
| | spatial streams | | |
| All except | Max Tx Power | As in association | |
| ACK, BA, CTS | Recommended | Max Tx power | For enabling STA |
| | Max TX power | | multi-communication |
| | | | concurrency |
| | Max MCS index | As in association | |
| | Max number of | As in association | |
| | spatial streams | | |

In accordance with Table 2 above and in one embodiment, if a WiFi STA (e.g., the one or more user devices 120 of FIG. 1) is under in-device coexistence constraints, then the STA may prefer to transmit in lower than a maximum transmission power (i.e., Recommended Max Tx Power) to avoid interference with concurrently transmitted Bluetooth and/or LTE signals. The WiFi STA may further prefer to transmit in a lower modulation and coding scheme (i.e., Max MCS index). The WiFi STA may further prefer to transmit in a specific number of spatial streams (i.e., “Max number of spatial streams”). In one embodiment, the IE 104 may be separated for: acknowledgement (ACK), block acknowledgment (BA), and clear-to-send (CTS) frames which are triggered during a downlink transaction from the AP to the WiFi STA and all frames except ACK, BA, and CTS frames for uplink transactions from the WiFi STA to the AP.

In one embodiment, once a STA is under in-device coexistence, it may send a frame to the AP with the IE 104 discussed above including changed PHY parameters of its transmissions. Once the AP knows the preferred transmission parameters, it may change trigger frame requirements for that specific STA and thus the STA may be able to obey triggering requests while still maintaining in-device coexistence.

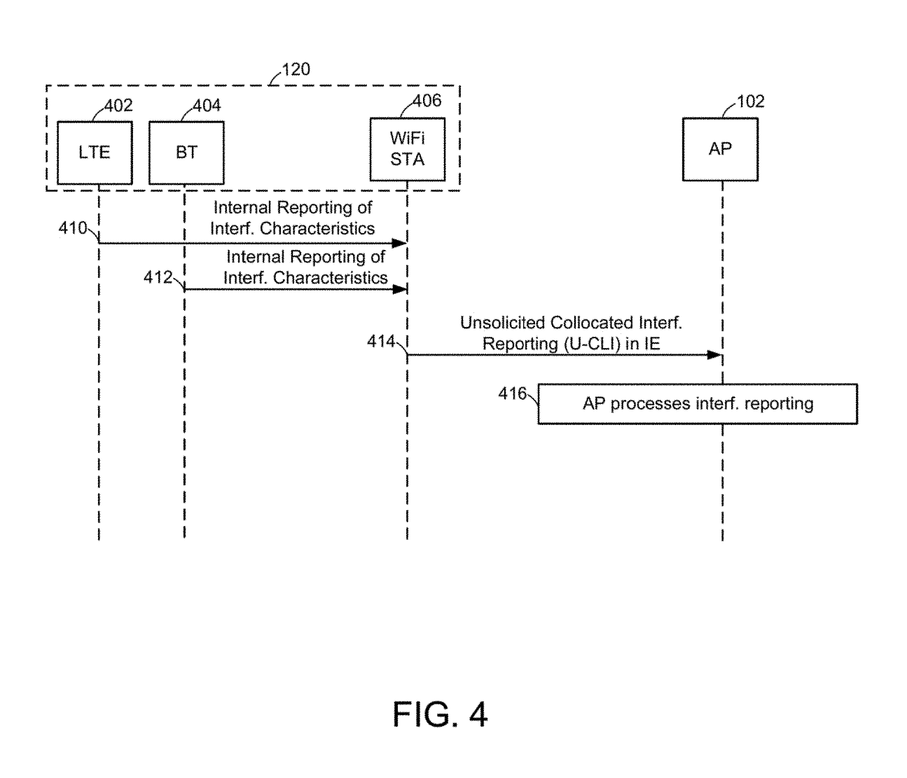

FIG. 4 depicts an illustrative schematic diagram of an information element based communication for unsolicited collocated interference reporting, in accordance with one or more example embodiments of the present disclosure. In one embodiment, a device (e.g., the user device(s) 120) may include a collocated LTE component 402, a Bluetooth (BT) component 404, and a WiFi station (STA) component 406. In one embodiment, the device may be an802.11ax WiFi STA network device. The LTE component 402 and the BT component 404 may send internal reporting of interference characteristics 410 and 412, respectively, to the WiFi STA component 406. Upon receiving the reported interference characteristics 410 and 412, the WiFi STA component 406 may generate an information element (e.g., IE 104) including an unsolicited collocated interference report 414 and send the report to the AP 102. The AP 102 may then process 416 the collocated interference report. For example, the AP 102 may take into account allowed reception and transmission timing data that may be included in the collocated interference report and use this data for scheduling the transmission of data to the WiFi STA component 406. As another example, the AP 102 may take into account the received collocated interference characteristics included in the collocated interference report and use these characteristics when setting PHY transmission parameters for transmitting data to the WiFi STA component 406. In one embodiment, the AP 102 may use data contained in the interference report and execute one or more algorithms to improve overall WiFi performance. Some non-limiting algorithms may include AP soft rate scaling, AP channel switching, and dynamic AP aggregation and fragmentation duration limits.

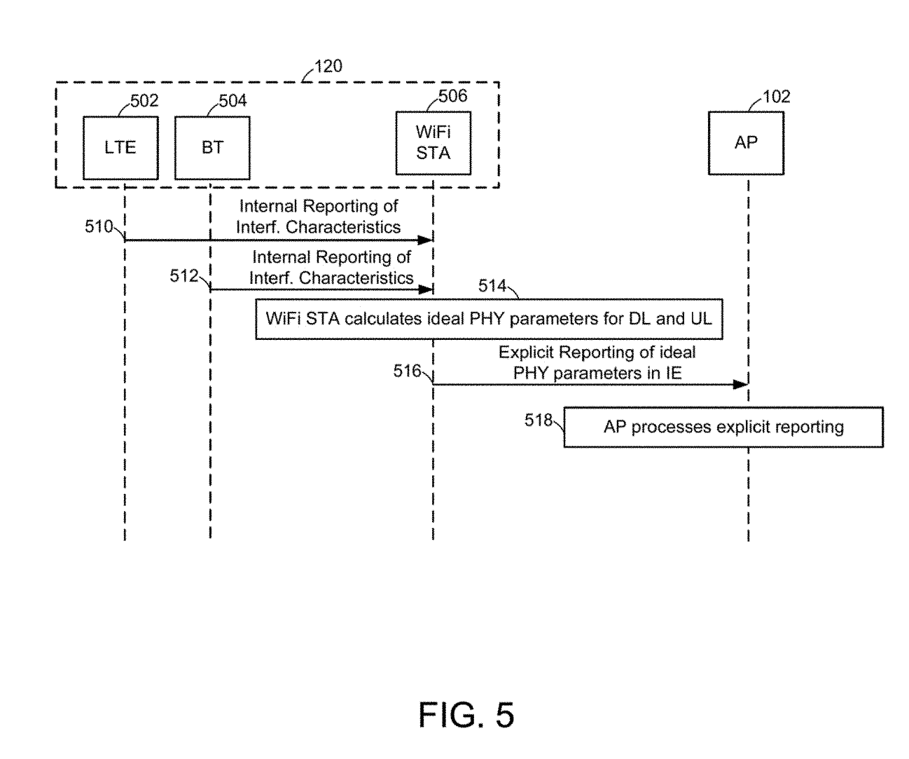

FIG. 5 depicts an illustrative schematic diagram of an information element based communication for physical layer parameter control, in accordance with one or more example embodiments of the present disclosure. In one embodiment, a device (e.g., the user device(s) 120) may include a collocated LTE component 502, a Bluetooth (BT) component 504, and a WiFi station (STA) component 506. In one embodiment, the device may be an 802.11ax WiFi STA network device. The LTE component 502 and the BT component 504 may send internal reporting of interference characteristics 510 and 512, respectively, to the WiFi STA component 506. Upon receiving the reported interference characteristics 510 and 512, the WiFi STA component 506 may calculate 514 ideal PHY parameters for downlink and uplink communications with the AP 102. The WiFi STA component 506 may then generate an information element (e.g., IE 104) to explicitly report 516 the ideal PHY parameters to the AP 102 without solicitation from the AP 102. Thus, the IE 104 is sent to the AP 102 unsolicited. The AP 102 may then process 518 the ideal PHY parameters explicitly reported in the IE 104 by the WiFi STA component 506. For example, the IE 104 may indicate that the WiFi STA component 506 prefers to transmit ACK, BA and CTS frames with limited transmission power, or the WiFi STA component 506 prefers to transit ACK, BA and CTS frames with limited MCS, or the WiFi STA component 506 prefers to transmit ACK, BA and CTS frames with a limited number of spatial streams, or the WiFi STA component 506 may indicate that the WiFi STA component 506 prefers to transmit all frames except for ACK, BA and CTS frames with limited transmission power, or the WiFi STA component 506 may indicate that the WiFi STA component 506 prefers to transmit all frames except for ACK, BA and CTS frames with limited MCS, or the WiFi STA component 506 may indicate that the WiFi STA component 506 prefers to transmit all frames except for ACK, BA and CTS frames with a limited number of spatial streams, or the ideal PHY parameters should be considered when issuing a trigger frame for the WiFi STA component 506.

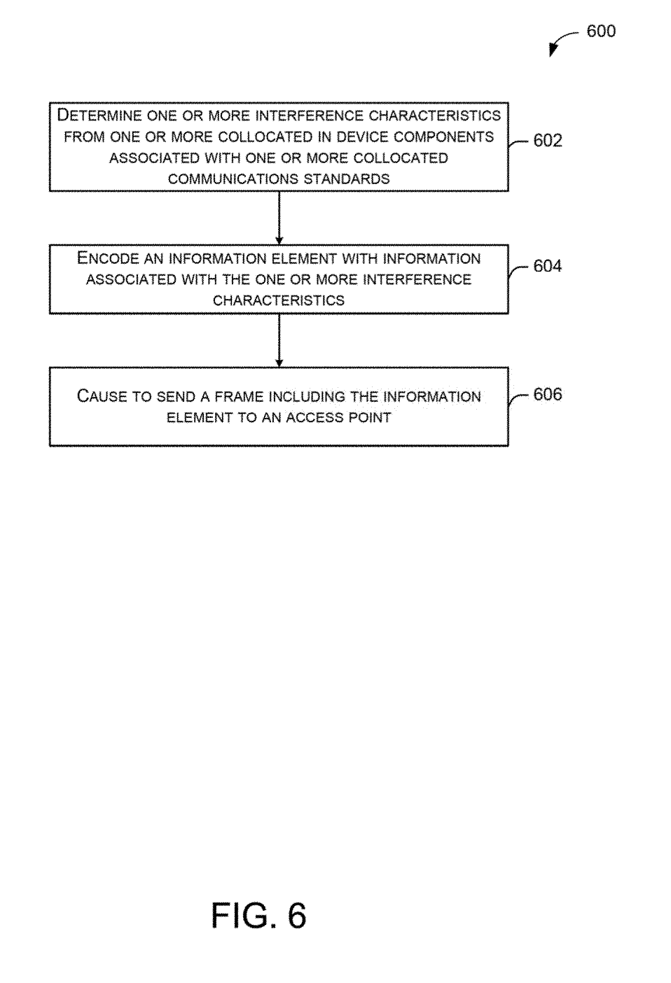

FIG. 6 depicts a flow diagram of an illustrative process 600 for an illustrative unsolicited collocated interference reporting and physical layer parameter control system, in accordance with one or more example embodiments of the present disclosure.

At block 602, a device (e.g., the user device(s) 120 of FIG. 1) may determine one or more interference characteristics from one or more collocated in-device components associated with one or more collocated communications standards. The collocated communications standards may include, for example, an LTE standard or a Bluetooth standard. In one embodiment, the one or more interference characteristics may include one or more of an interference level, an interference center frequency, an interference bandwidth, an interference level accuracy, an interference index, an interference interval, an interference burst length, an interference start time, or an interference duty cycle. In one embodiment, the one or more interference characteristics may include one or more physical layer parameters including, without limitation, a maximum transmit power, a recommended transmit power, a maximum modulation and coding scheme, and a maximum number of spatial streams. In one embodiment, the device may utilize the maximum number of spatial streams for transmitting an acknowledgement, a block acknowledgement, and a clear-to-send frame to an access point (e.g., the AP 102 of FIG. 1).

At block 604, the device may encode an information element with information associated with one or more interference characteristics. In one embodiment, the information may be a collocated interference report indicating interference the device is subject to by the one or more interference characteristics. In one embodiment, the information may include one or more physical layer parameters to operate with the one or more collocated communications standards.

At block 606, the device may cause to send a frame including the information element to an access point. It is understood that the above descriptions are for purposes of illustration and are not meant to be limiting.

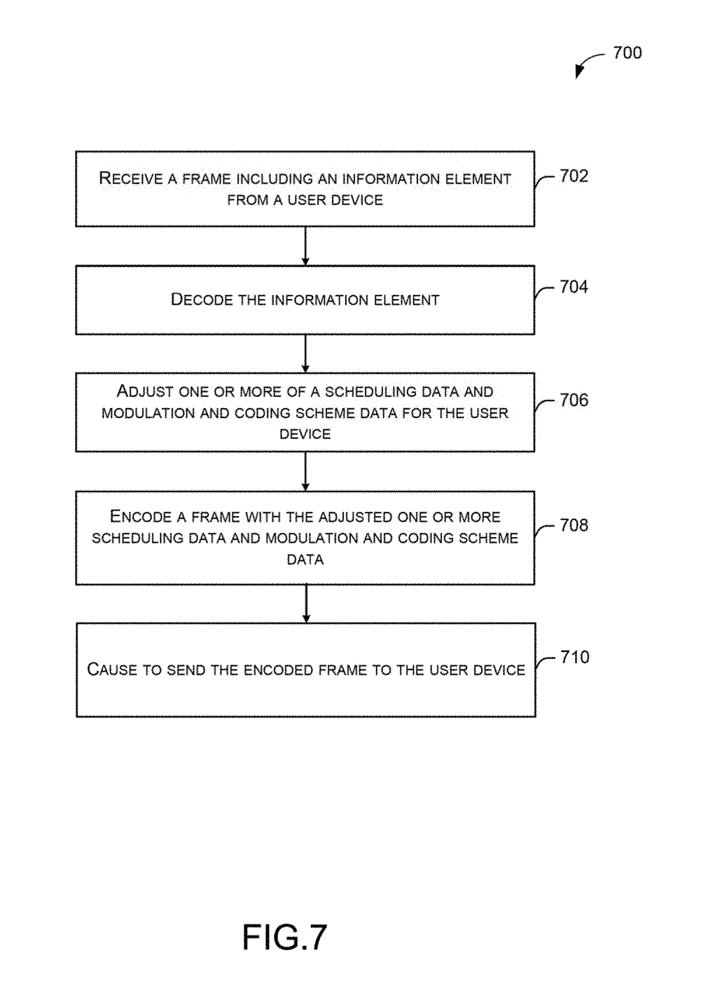

FIG. 7 depicts a flow diagram of an illustrative process 700 for an illustrative unsolicited collocated interference reporting and physical layer parameter control system, in accordance with one or more example embodiments of the present disclosure.

At block 702, an AP (e.g., the AP 102 of FIG. 1) may receive a frame including an information element from a user device (e.g., the user device(s) 120 of FIG. 1). The information element may include information associated with one or more interference characteristics from one or more collocated in-device components, in the user device, that are associated with one or more collocated communications standards. The collocated communications standards may include, for example, an LTE standard or a Bluetooth standard. In one embodiment, the one or more interference characteristics may include one or more of an interference level, an interference center frequency, an interference bandwidth, an interference level accuracy, an interference index, an interference interval, an interference burst length, an interference start time, or an interference duty cycle. In one embodiment, the one or more interference characteristics may include one or more physical layer parameters to operate with the one or more collocated communications standards. The one or more physical layer parameters may include, without limitation, a maximum transmit power, a recommended transmit power, a maximum modulation and coding scheme, and a maximum number of spatial streams.

At block 704, the AP may decode the information element. For example, the AP 102 may decode the IE 104 (received in the frame 106) to determine the one or more interference characteristics discussed above with respect to block 702.

At block 706, the AP may adjust one or more of a scheduling data and modulation and coding scheme data for the user device. For example, the AP 102 may take into account allowed reception and transmission timing data that may be included in the one or more interference characteristics and use this data for scheduling the transmission of data to the user device(s) 120. As another example, the AP 102 may take into account the received one or more interference characteristics and utilize them when setting PHY transmission parameters for transmitting data to the user device(s) 120. For example, interference characteristics may indicate (to the AP 102) that the user device(s) 120 prefer to transmit in a lower modulation and coding scheme (i.e., Max MCS index).

At block 708, the AP may encode a frame with the adjusted one or more of the scheduling data and the modulation and coding scheme data for communication to the user device. For example, the encoded frame may be a trigger frame for the user device incorporating the user device's coexistence communications requirements based on, for example, the adjusted scheduling data and modulation and coding scheme data.

At block 710, the AP may cause to send the encoded frame to the user device. As discussed above, the encoded frame may be a trigger frame with new requirements based on data received in the information element received from the user device. It is understood that the above descriptions are for purposes of illustration and are not meant to be limiting.

FIG. 8 shows a functional diagram of an exemplary communication station 800 in accordance with some embodiments. In one embodiment, FIG. 8 illustrates a functional block diagram of a communication station that may be suitable for use as an AP 102 (FIG. 1) or a user device 120 (FIG. 1) in accordance with some embodiments. The communication station 800 may also be suitable for use as a handheld device, a mobile device, a cellular telephone, a smartphone, a tablet, a netbook, a wireless terminal, a laptop computer, a wearable computer device, a femtocell, a high data rate (HDR) subscriber station, an access point, an access terminal, or other personal communication system (PCS) device.

The communication station 800 may include communications circuitry 802 and a transceiver 810 for transmitting and receiving signals to and from other communication stations using one or more antennas 801. The communications circuitry 802 may include circuitry that can operate the physical layer (PHY) communications and/or media access control (MAC) communications for controlling access to the wireless medium, and/or any other communications layers for transmitting and receiving signals. The communication station 800 may also include processing circuitry 806 and memory 808 arranged to perform the operations described herein. In some embodiments, the communications circuitry 802 and the processing circuitry 706 may be configured to perform operations detailed in FIGS. 1-6.

In accordance with some embodiments, the communications circuitry 802 may be arranged to contend for a wireless medium and configure frames or packets for communicating over the wireless medium. The communications circuitry 802 may be arranged to transmit and receive signals. The communications circuitry 802 may also include circuitry for modulation/demodulation, upconversion/downconversion, filtering, amplification, etc. In some embodiments, the processing circuitry 806 of the communication station 800 may include one or more processors. In other embodiments, two or more antennas 801 may be coupled to the communications circuitry 802 arranged for sending and receiving signals. The memory 808 may store information for configuring the processing circuitry 806 to perform operations for configuring and transmitting message frames and performing the various operations described herein. The memory 808 may include any type of memory, including non-transitory memory, for storing information in a form readable by a machine (e.g., a computer). For example, the memory 808 may include a computer-readable storage device, read-only memory (ROM), random-access memory (RAM), magnetic disk storage media, optical storage media, flash-memory devices and other storage devices and media.

In some embodiments, the communication station 800 may be part of a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a medical device (e.g., a heart rate monitor, a blood pressure monitor, etc.), a wearable computer device, or another device that may receive and/or transmit information wirelessly.

In some embodiments, the communication station 800 may include one or more antennas 801. The antennas 801 may include one or more directional or omnidirectional antennas, including, for example, dipole antennas, monopole antennas, patch antennas, loop antennas, microstrip antennas, or other types of antennas suitable for transmission of RF signals. In some embodiments, instead of two or more antennas, a single antenna with multiple apertures may be used. In these embodiments, each aperture may be considered a separate antenna. In some multiple-input multiple-output (MIMO) embodiments, the antennas may be effectively separated for spatial diversity and the different channel characteristics that may result between each of the antennas and the antennas of a transmitting station.

In some embodiments, the communication station 800 may include one or more of a keyboard, a display, a non-volatile memory port, multiple antennas, a graphics processor, an application processor, speakers, and other mobile device elements. The display may be an LCD screen including a touch screen.

Although the communication station 800 is illustrated as having several separate functional elements, two or more of the functional elements may be combined and may be implemented by combinations of software-configured elements, such as processing elements including digital signal processors (DSPs), and/or other hardware elements. For example, some elements may include one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements of the communication station 800 may refer to one or more processes operating on one or more processing elements.

Certain embodiments may be implemented in one or a combination of hardware, firmware, and software. Other embodiments may also be implemented as instructions stored on a computer-readable storage device, which may be read and executed by at least one processor to perform the operations described herein. A computer-readable storage device may include any non-transitory memory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media. In some embodiments, the communication station 800 may include one or more processors and may be configured with instructions stored on a computer-readable storage device memory.

FIG. 9 illustrates a block diagram of an example of a machine 900 or system upon which any one or more of the techniques (e.g., methodologies) discussed herein may be performed. In other embodiments, the machine 900 may operate as a standalone device or may be connected (e.g., networked) to other machines. In a networked deployment, the machine 900 may operate in the capacity of a server machine, a client machine, or both in server-client network environments. In an example, the machine 900 may act as a peer machine in peer-to-peer (P2P) (or other distributed) network environments. The machine 900 may be a personal computer (PC), a tablet PC, a set-top box (STB), a personal digital assistant (PDA), a mobile telephone, a wearable computer device, a web appliance, a network router, a switch or bridge, or any machine capable of executing instructions (sequential or otherwise) that specify actions to be taken by that machine, such as a base station. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), or other computer cluster configurations.

Examples, as described herein, may include or may operate on logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In another example, the hardware may include configurable execution units (e.g., transistors, circuits, etc.) and a computer readable medium containing instructions where the instructions configure the execution units to carry out a specific operation when in operation. The configuring may occur under the direction of the executions units or a loading mechanism. Accordingly, the execution units are communicatively coupled to the computer-readable medium when the device is operating. In this example, the execution units may be a member of more than one module. For example, under operation, the execution units may be configured by a first set of instructions to implement a first module at one point in time and reconfigured by a second set of instructions to implement a second module at a second point in time.

The machine (e.g., computer system) 900 may include a hardware processor 902 (e.g., a central processing unit (CPU), a graphics processing unit (GPU), a hardware processor core, or any combination thereof), a main memory 904 and a static memory 906, some or all of which may communicate with each other via an interlink (e.g., bus) 908. The machine 900 may further include a power management device 932, a graphics display device 910, an alphanumeric input device 912 (e.g., a keyboard), and a user interface (UI) navigation device 914 (e.g., a mouse). In an example, the graphics display device 910, alphanumeric input device 912, and UI navigation device 914 may be a touch screen display. The machine 900 may additionally include a storage device (i.e., drive unit) 916, a signal generation device 918 (e.g., a speaker), an information element coding device 919, a network interface device/transceiver 920 coupled to antenna(s) 930, and one or more sensors 928, such as a global positioning system (GPS) sensor, a compass, an accelerometer, or other sensor. The machine 900 may include an output controller 934, such as a serial (e.g., universal serial bus (USB), parallel, or other wired or wireless (e.g., infrared (IR), near field communication (NFC), etc.) connection to communicate with or control one or more peripheral devices (e.g., a printer, a card reader, etc.)).

The storage device 916 may include a machine readable medium 922 on which is stored one or more sets of data structures or instructions 924 (e.g., software) embodying or utilized by any one or more of the techniques or functions described herein. The instructions 924 may also reside, completely or at least partially, within the main memory 904, within the static memory 906, or within the hardware processor 902 during execution thereof by the machine 900. In an example, one or any combination of the hardware processor 902, the main memory 904, the static memory 906, or the storage device 916 may constitute machine-readable media.

The information element coding device 919 may be carry out or perform any of the operations and processes (e.g., processes 600 and 700) described and shown above. For example, the information element coding device 919 may be configured to determine one or more interference characteristics from one or more collocated communications standards, encode an information element with information associated with the one or more interference characteristics, and cause to send a frame comprising the information element to an access point. The one or more collocated communications standards comprises one or more of a Long Term Evolution (LTE) standard and a Bluetooth standard.

In one embodiment, the information associated with the one or more interference characteristics may include a collocated interference report indicating interference the device is subject to by the one or more interference characteristics. In one embodiment, the information associated with the one or more interference characteristics may include one or more physical layer parameters to operate with the one or more collocated communications standards.

The one or more physical layer parameters ma include one or more of a maximum transmit power, a recommended maximum transmit power, a maximum modulation and coding scheme, and a maximum number of spatial streams. The information element coding device 919 may utilize the maximum number of spatial streams for transmitting an acknowledgement, a block acknowledgement, and a clear-to-send frame.

The one or more interference characteristics comprises one or more of an interference level, an interference center frequency, an interference bandwidth, an interference level accuracy, an interference index, an interference interval, an interference burst length, an interference start time, and an interference duty cycle. It is understood that the above descriptions are for purposes of illustration and are not meant to be limiting.

While the machine-readable medium 922 is illustrated as a single medium, the term “machine-readable medium” may include a single medium or multiple media (e.g., a centralized or distributed database, and/or associated caches and servers) configured to store the one or more instructions 924.

Various embodiments may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

The term “machine-readable medium” may include any medium that is capable of storing, encoding, or carrying instructions for execution by the machine 900 and that cause the machine 900 to perform any one or more of the techniques of the present disclosure, or that is capable of storing, encoding, or carrying data structures used by or associated with such instructions. Non-limiting machine-readable medium examples may include solid-state memories and optical and magnetic media. In an example, a massed machine-readable medium includes a machine-readable medium with a plurality of particles having resting mass. Specific examples of massed machine-readable media may include non-volatile memory, such as semiconductor memory devices (e.g., electrically programmable read-only memory (EPROM), or electrically erasable programmable read-only memory (EEPROM)) and flash memory devices; magnetic disks, such as internal hard disks and removable disks; magneto-optical disks; and CD-ROM and DVD-ROM disks.

The instructions 924 may further be transmitted or received over a communications network 926 using a transmission medium via the network interface device/transceiver 920 utilizing any one of a number of transfer protocols (e.g., frame relay, internet protocol (IP), transmission control protocol (TCP), user datagram protocol (UDP), hypertext transfer protocol (HTTP), etc.). Example communications networks may include a local area network (LAN), a wide area network (WAN), a packet data network (e.g., the Internet), mobile telephone networks (e.g., cellular networks), plain old telephone (POTS) networks, wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, and peer-to-peer (P2P) networks, among others. In an example, the network interface device/transceiver 920 may include one or more physical jacks (e.g., Ethernet, coaxial, or phone jacks) or one or more antennas to connect to the communications network 926. In an example, the network interface device/transceiver 920 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the machine 900 and includes digital or analog communications signals or other intangible media to facilitate communication of such software. The operations and processes (e.g., processes 600 and 700) described and shown above may be carried out or performed in any suitable order as desired in various implementations. Additionally, in certain implementations, at least a portion of the operations may be carried out in parallel. Furthermore, in certain implementations, less than or more than the operations described may be performed.

The word “exemplary” is used herein to mean “serving as an example, instance, or illustration.” Any embodiment described herein as “exemplary” is not necessarily to be construed as preferred or advantageous over other embodiments. The terms “computing device,” “user device,” “communication station,” “station,” “handheld device,” “mobile device,” “wireless device” and “user equipment” (UE) as used herein refers to a wireless communication device such as a cellular telephone, a smartphone, a tablet, a netbook, a wireless terminal, a laptop computer, a femtocell, a high data rate (HDR) subscriber station, an access point, a printer, a point of sale device, an access terminal, or other personal communication system (PCS) device. The device may be either mobile or stationary.

As used within this document, the term “communicate” is intended to include transmitting, or receiving, or both transmitting and receiving. This may be particularly useful in claims when describing the organization of data that is being transmitted by one device and received by another, but only the functionality of one of those devices is required to infringe the claim. Similarly, the bidirectional exchange of data between two devices (both devices transmit and receive during the exchange) may be described as “communicating,” when only the functionality of one of those devices is being claimed. The term “communicating” as used herein with respect to a wireless communication signal includes transmitting the wireless communication signal and/or receiving the wireless communication signal. For example, a wireless communication unit, which is capable of communicating a wireless communication signal, may include a wireless transmitter to transmit the wireless communication signal to at least one other wireless communication unit, and/or a wireless communication receiver to receive the wireless communication signal from at least one other wireless communication unit.

As used herein, unless otherwise specified, the use of the ordinal adjectives “first,” “second,” “third,” etc., to describe a common object, merely indicates that different instances of like objects are being referred to and are not intended to imply that the objects so described must be in a given sequence, either temporally, spatially, in ranking, or in any other manner.

The term “access point” (AP) as used herein may be a fixed station. An access point may also be referred to as an access node, a base station, or some other similar terminology known in the art. An access terminal may also be called a mobile station, user equipment (UE), a wireless communication device, or some other similar terminology known in the art. Embodiments disclosed herein generally pertain to wireless networks. Some embodiments may relate to wireless networks that operate in accordance with one of the IEEE 802.11 standards.

Some embodiments may be used in conjunction with various devices and systems, for example, a personal computer (PC), a desktop computer, a mobile computer, a laptop computer, a notebook computer, a tablet computer, a server computer, a handheld computer, a handheld device, a personal digital assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless access point (AP), a wired or wireless router, a wired or wireless modem, a video device, an audio device, an audio-video (A/V) device, a wired or wireless network, a wireless area network, a wireless video area network (WVAN), a local area network (LAN), a wireless LAN (WLAN), a personal area network (PAN), a wireless PAN (WPAN), and the like.

Some embodiments may be used in conjunction with one way and/or two-way radio communication systems, cellular radio-telephone communication systems, a mobile phone, a cellular telephone, a wireless telephone, a personal communication system (PCS) device, a PDA device which incorporates a wireless communication device, a mobile or portable global positioning system (GPS) device, a device which incorporates a GPS receiver or transceiver or chip, a device which incorporates an RFID element or chip, a multiple input multiple output (MIMO) transceiver or device, a single input multiple output (SIMO) transceiver or device, a multiple input single output (MISO) transceiver or device, a device having one or more internal antennas and/or external antennas, digital video broadcast (DVB) devices or systems, multi-standard radio devices or systems, a wired or wireless handheld device, e.g., a smartphone, a wireless application protocol (WAP) device, or the like.

Some embodiments may be used in conjunction with one or more types of wireless communication signals and/or systems following one or more wireless communication protocols, for example, radio frequency (RF), infrared (IR), frequency-division multiplexing (FDM), orthogonal FDM (OFDM), time-division multiplexing (TDM), time-division multiple access (TDMA), extended TDMA (E-TDMA), general packet radio service (GPRS), extended GPRS, code-division multiple access (CDMA), wideband CDMA (WCDMA), CDMA 2000, single-carrier CDMA, multi-carrier CDMA, multi-carrier modulation (MDM), discrete multi-tone (DMT), Bluetooth®, global positioning system (GPS), Wi-Fi, Wi-Max, ZigBee, ultra-wideband (UWB), global system for mobile communications (GSM), 2G, 2.5G, 3G, 3.5G, 4G, fifth generation (5G) mobile networks, 3GPP, long term evolution (LTE), LTE advanced, enhanced data rates for GSM Evolution (EDGE), or the like. Other embodiments may be used in various other devices, systems, and/or networks.

According to example embodiments of the disclosure, there may be a device. The device may include at least one memory device having instructions programmed thereon and at least one processor configured to access the at least one memory device and may be further configured to execute the instructions to: determine one or more interference characteristics from one or more collocated in-device components associated with one or more collocated communications standards, encode an information element with information associated with the one or more interference characteristics, and cause to send a frame comprising the information element to an access point.

Implementation may include one or more of the following features. The information element may comprise a collocated interference report indicating interference the device is subject to by the interference characteristics. The information may comprise one or more physical layer parameters, wherein the one or more physical layer parameters comprises one or more of a maximum transmit power, a recommended maximum transmit power, a maximum modulation and coding scheme, and a maximum number of spatial streams, to operate with the one or more collocated communication standards. The at least one processor of the device may be configured to execute instructions to utilize at least one of the maximum number of spatial streams for transmitting an acknowledgement frame, a block acknowledgement frame, or a clear-to-send frame. The interference characteristics may comprise one or more of: an interference level, an interference center frequency, an interference bandwidth, an interference level accuracy, an interference index, an interference interval, an interference burst length, an interference start time, and an interference duty cycle. The collocated communication standards may comprise one or more of a Long Term Evolution (LTE) standard and a Bluetooth standard. The device may further comprise a transceiver configured to transmit and receive wireless signals and an antenna coupled to the transceiver.

According to example embodiments of the disclosure, there may be a non-transitory computer-readable medium. The medium may store instructions which when executed perform operations comprising: determining one or more interference characteristics from one or more collocated in-device components associated with one or more collocated communications standards, encoding an information element with information associated with the one or more interference characteristics, and causing to send a frame comprising the information element to an access point.

Implementation may include one or more of the following features. The information element may comprise a collocated interference report indicating interference the device is subject to by the interference characteristics. The information may comprise one or more physical layer parameters, wherein the one or more physical layer parameters comprises one or more of a maximum transmit power, a recommended maximum transmit power, a maximum modulation and coding scheme, and a maximum number of spatial streams, to operate with the one or more collocated communication standards. The computer-executable instructions may cause the processor to further perform operations comprising utilizing at least one of the maximum number of spatial streams for transmitting an acknowledgement frame, a block acknowledgement frame, or a clear-to-send frame. The interference characteristics may comprise one or more of: an interference level, an interference center frequency, an interference bandwidth, an interference level accuracy, an interference index, an interference interval, an interference burst length, an interference start time, and an interference duty cycle. The collocated communication standards may comprise one or more of a Long Term Evolution (LTE) standard and a Bluetooth standard.

According to example embodiments of the disclosure, there may be a method. The method may comprise: determining one or more interference characteristics from one or more collocated in-device components associated with one or more collocated communications standards, encoding an information element with information associated with the one or more interference characteristics, and causing to send a frame comprising the information element to an access point.

Implementation may include one or more of the following features. The information element may comprise a collocated interference report indicating interference the device is subject to by the interference characteristics. The information may comprise one or more physical layer parameters, wherein the one or more physical layer parameters comprises one or more of a maximum transmit power, a recommended maximum transmit power, a maximum modulation and coding scheme, and a maximum number of spatial streams, to operate with the one or more collocated communication standards. The method may further comprise utilizing at least one of the maximum number of spatial streams for transmitting an acknowledgement frame, a block acknowledgement frame, or a clear-to-send frame. The interference characteristics may comprise one or more of: an interference level, an interference center frequency, an interference bandwidth, an interference level accuracy, an interference index, an interference interval, an interference burst length, an interference start time, and an interference duty cycle. The collocated communication standards may comprise one or more of a Long Term Evolution (LTE) standard and a Bluetooth standard.

According to example embodiments of the disclosure, there may be an apparatus. The method may comprise: means for determining one or more interference characteristics from one or more collocated in-device components associated with one or more collocated communications standards, means for encoding an information element with information associated with the one or more interference characteristics, and means for causing to send a frame comprising the information element to an access point.

Implementation may include one or more of the following features. The information element may comprise a collocated interference report indicating interference the device is subject to by the interference characteristics. The information may comprise one or more physical layer parameters, wherein the one or more physical layer parameters comprises one or more of a maximum transmit power, a recommended maximum transmit power, a maximum modulation and coding scheme, and a maximum number of spatial streams, to operate with the one or more collocated communication standards. The apparatus may further comprise means for utilizing at least one of the maximum number of spatial streams for transmitting an acknowledgement frame, a block acknowledgement frame, or a clear-to-send frame. The interference characteristics may comprise one or more of: an interference level, an interference center frequency, an interference bandwidth, an interference level accuracy, an interference index, an interference interval, an interference burst length, an interference start time, and an interference duty cycle. The collocated communication standards may comprise one or more of a Long Term Evolution (LTE) standard and a Bluetooth standard.

Certain aspects of the disclosure are described above with reference to block and flow diagrams of systems, methods, apparatuses, and/or computer program products according to various implementations. It will be understood that one or more blocks of the block diagrams and flow diagrams, and combinations of blocks in the block diagrams and the flow diagrams, respectively, may be implemented by computer-executable program instructions. Likewise, some blocks of the block diagrams and flow diagrams may not necessarily need to be performed in the order presented, or may not necessarily need to be performed at all, according to some implementations.

These computer-executable program instructions may be loaded onto a special-purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable storage media or memory that may direct a computer or other programmable data processing apparatus to function in a particular manner, such that the instructions stored in the computer-readable storage media produce an article of manufacture including instruction means that implement one or more functions specified in the flow diagram block or blocks. As an example, certain implementations may provide for a computer program product, comprising a computer-readable storage medium having a computer-readable program code or program instructions implemented therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language is not generally intended to imply that features, elements, and/or operations are in any way required for one or more implementations or that one or more implementations necessarily include logic for deciding, with or without user input or prompting, whether these features, elements, and/or operations are included or are to be performed in any particular implementation.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

1-25. (canceled)

26. A device, comprising:
at least one memory that stores computer-executable instructions; and
at least one processor configured to access the at least one memory, wherein the at least one processor is configured to execute the computer-executable instructions to:
determine one or more interference characteristics from one or more collocated in-device components associated with one or more collocated communications standards;
encode an information element with information associated with the one or more interference characteristics; and
cause to send a frame comprising the information element to an access point.

27. The device of claim 26, wherein the information comprises a collocated interference report indicating interference the device is subject to by the one or more interference characteristics.

28. The device of claim 26, wherein the information comprises one or more physical layer parameters to operate with the one or more collocated communications standards.

29. The device of claim 28, wherein the one or more physical layer parameters comprises one or more of a maximum transmit power, a recommended maximum transmit power, a maximum modulation and coding scheme, and a maximum number of spatial streams.

30. The device of claim 29, wherein the at least one processor is further configured to execute the computer-executable instructions to utilize at least one of the maximum number of spatial streams for transmitting an acknowledgement frame, a block acknowledgement frame, or a clear-to-send frame.

31. The device of claim 26, wherein the one or more interference characteristics comprises one or more of an interference level, an interference center frequency, an interference bandwidth, an interference level accuracy, an interference index, an interference interval, an interference burst length, an interference start time, and an interference duty cycle.

32. The device of claim 31, wherein the one or more collocated communications standards comprises one or more of a Long Term Evolution (LTE) standard and a Bluetooth standard.

33. The device of claim 26, further comprising a transceiver configured to transmit and receive wireless signals.

34. The device of claim 33, further comprising one or more antennas coupled to the transceiver.

35. A non-transitory computer-readable medium storing computer-executable instructions which when executed by one or more processors result in performing operations comprising:
determining one or more interference characteristics from one or more collocated in
device components associated with one or more collocated communications standards;
encoding an information element with information associated with the one or more interference characteristics; and
causing to send a frame comprising the information element to an access point.

36. The non-transitory computer-readable medium of claim 35, wherein the information comprises a collocated interference report indicating interference the device is subject to by the one or more interference characteristics.

37. The non-transitory computer-readable medium of claim 35, wherein the information comprises one or more physical layer parameters to operate with the one or more collocated communications standards.

38. The non-transitory computer-readable medium of claim 37, wherein the one or more physical layer parameters comprises one or more of a maximum transmit power, a recommended maximum transmit power, a maximum modulation and coding scheme, and a maximum number of spatial streams.

39. A method comprising:
receiving, by an access point, a frame comprising an information element from a user device, the information element comprising information associated with one or more interference characteristics, the one or more interference characteristics associated with one or more collocated communications standards;
decoding the information element;
adjusting one or more of a scheduling data and modulation and coding scheme data for the user device;
encoding a frame with the adjusted one or more of the scheduling data and the modulation and coding scheme data; and
causing to send the encoded frame to the user device.

40. The method of claim 39, wherein the information comprises a collocated interference report indicating interference the device is subject to by the one or more interference characteristics.

41. The method of claim 39, wherein the information comprises one or more physical layer parameters to operate with the one or more collocated communications standards.

42. The method of claim 41, wherein the one or more physical layer parameters comprises one or more of a maximum transmit power, a recommended maximum transmit power, a maximum modulation and coding scheme, and a maximum number of spatial streams.

43. The method of claim 42, wherein the method further comprises utilizing the maximum number of spatial streams for transmitting an acknowledgement, a block acknowledgement, or a clear-to-send frame.

44. The method of claim 39, wherein the one or more interference characteristics comprises one or more of an interference level, an interference center frequency, an interference bandwidth, an interference level accuracy, an interference index, an interference interval, an interference burst length, an interference start time, and an interference duty cycle.

45. The method of claim 44, wherein the one or more collocated communications standards comprises one or more of a Long Term Evolution (LTE) standard and a Bluetooth standard.
